(19) United States
(12) Patent Application Publication
(10) Pub. No.: US 2009/0118859 A1
(43) Pub. Date: May 7, 2009

(54) Ocean Fertilization Project Identification and Inventorying

(75) Inventors: Dan Whaley, San Francisco, CA (US); Margaret Leinen, Alexandria, VA (US); Kevin Whilden, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: CLIMOS, San Francisco, CA (US)

(21) Appl. No.: 12/267,405

(22) Filed: Nov. 7, 2008

Related U.S. Application Data
(60) Provisional application No. 60/986,281, filed on Nov. 7, 2007.

(51) Int. Cl. G06F 7/06; G06Q 10/00

(52) U.S. Cl. 700/214; 705/28; 700/225; 700/229

(57) ABSTRACT

Systems and methods for coordinating ocean fertilization efforts and inventorying carbon storage unit segments in ocean fertilization projects are disclosed. The system and methods can be used to segment and identify units of carbon sequestered for storage with additional information associated with the projects. The system and methods inventory carbon storage unit segments, segment the project into single carbon unit segments, associate an identifier with each segment, and index the identified segments and associated information. The system can be implemented via a computer system.

### RELATED APPLICATION

This application claims the benefit of U.S. Patent Provisional Application No. 60/986,281, entitled “System And Methods For Generating and Inventorying Sequestered Carbon,” filed Nov. 7, 2007, which is incorporated herein by reference for all purposes.

### FIELD OF THE INVENTION

This invention relates generally to the fields of oceanography and climatology. More specifically, the present invention relates to systems and methods for qualifying and quantifying the results of ocean fertilization activities. These system and methods are used in conjunction with ocean fertilization technology to generate carbon credits corresponding to quantities of carbon removed from the atmosphere for a requisite period of time. The systems and methods are useful for remediating the alarming increase in greenhouse gases such as, e.g., carbon dioxide resulting from the burning of fossil fuels.

### BACKGROUND OF THE INVENTION

Greenhouse gas levels are set by the relative rates at which they are added to and removed from the atmosphere. Greenhouse gas levels therefore can be lowered by reducing the rate at which they are added to the atmosphere such as, e.g., by reducing the overall rate of fossil fuel consumption to generate a corresponding decrease in greenhouse gas emissions, or by increasing the rate at which greenhouse gases are removed or sequestered. Emission reduction approaches include the use of alternative energy sources, such as solar power, wind power, geothermal power, fuel cell technology, in addition to increasing the use of more traditional clean sources of energy such as hydroelectric power. Reducing greenhouse gas emissions provides an important component of the overall strategy for reducing greenhouse gas levels. However, by itself, the emission reduction approach, while important, is incomplete. The amount of energy currently produced by non-fossil fuel energy sources is insufficient to supply the energy needs of industrialized nations, and so this approach can provide only a partial solution to the immediate and pressing problem of reducing atmospheric greenhouse gas levels. The emission reduction approach also fails to address the previously-accumulated atmospheric greenhouse gases which are the source of the present problems posed by global warming or climate change. In addition, several of the alternative energy sources such as, e.g., solar power, and geothermal power, require further technological improvements to increase efficiency before they are able to provide substantial offsets to fossil-fuel energy sources. Other alternative energy sources such as, e.g., hydrogen for use with fuel cell technology, require substantial infrastructure investments to develop them into viable alternatives to fossil fuels. As a result, fossil fuels remain a predominant energy source used in the world today.

Greenhouse gas levels also can be reduced by actively removing carbon dioxide from the atmosphere by stimulating the growth of photosynthetic organisms. Photosynthesis removes carbon dioxide from the atmosphere or water and incorporates or “fixes” it into the structure of the living organism. The most common types of photosynthetic organisms are land plants and aquatic photosynthetic organisms. Thus, increased plantings of trees or promoting growth of photosynthetic organisms provide two approaches to augmenting the rate at which the greenhouse gas, carbon dioxide (CO2), is removed from the atmosphere. The shortcomings associated with planting trees for the purpose of fixing CO2 include slow growth rate, and tendency to burn which returns CO2 back to the atmosphere and presents significant problems for forestry project developers to guarantee the permanence of carbon reductions. These factors have made it very difficult for the carbon market to monetize carbon reductions from forestry into certified carbon credits, and the largest regulatory carbon market (The European Trading System) currently excludes the trading of forestry carbon credits In addition, trees require allocation of substantial amounts of land mass per ton of fixed carbon. In northern latitudes, growing trees can actually decrease the albedo of the Earth's surface, allowing temperature to increase as the darker surface absorbs longwave radiation.

Ocean fertilization (OF), an approach that deliberately promotes the growth of marine photosynthetic organisms by the addition of one or more elements required for their growth to the ocean, and its use for mitigating climate changes arising from increased atmospheric greenhouse gas levels has been proposed, but to date has not been successfully commercialized. For example, known in the art are methods for sequestering CO2 by applying a fertilizer to an area of the surface of a deep open ocean, including, for example, an iron chelate fertilizer or urea.

Small scale tests of the ocean iron fertilization concept have been carried out in at least a dozen trials. To date, those trials have yielded results suggesting that while this approach has validated that ocean fertilization removes CO2, the prior art has failed to identify or enable the commercial pathway needed to bring large-scale ocean fertilization approaches to bear on the problem of remediating climate change. Among the shortcomings of the prior art are uncertain estimates of the efficiency of carbon export resulting from ocean fertilization, thus undercutting any expectation provided by the prior art that iron fertilization can be used to alleviate climate change. See Boyd et al., Mesoscale Iron Enrichment Experiments 1993-2005: Synthesis and Future Directions, Science, 315(5812): 612-617 (2007).

The commercial feasibility of iron fertilization to reduce greenhouse gases depends critically upon the ability to accurately estimate the amount of carbon fixed following a fertilization event (the ‘net carbon reductions’) and the length of time for which it will remain locked away from the atmosphere(the ‘permanence’ of carbon reductions). International policy makers for all carbon markets have established clear quality guidelines for certified carbon credits that require accurate verification of net carbon reductions with independent review. Likewise, these policy makers have set a standard of 100 years permanence for all certified carbon credits, and thus projects that cannot guarantee 100 years minimum permanence have difficulty in generating certified carbon reductions under major GHG regulatory frameworks.

### SUMMARY

Systems and methods for addressing climate change resulting from the accumulation of atmospheric greenhouse gases are disclosed. The systems and methods include segmenting fertilization projects, inventorying carbon sequestered in the deep ocean following ocean fertilization events, and tracking the physical parameters of a project such the data generated, methods, and location. The systems and methods disclosed can be used to coordinate ocean fertilization efforts. The system and methods can be used to convert results of ocean fertilization activity into carbon credits that can be traded in a carbon market. The system and methods can also be used to track and analyze non-carbon effects of the project, such as environmental, social, and financial effects.

One embodiment includes a system and method for inventorying carbon storage unit segments, including identifying fertilization project location information, segmenting the project into segments corresponding with a single unit of sequestered carbon, associating an identifier with each segment, and indexing the identified segments and associated information. The system also tracks the long-term movement of sequestered carbon using a general circulation model of ocean dynamics, thus the location of the sequestered carbon can be determined many years after the ocean circulation project has completed. Embodiments of the invention can be implemented via a computer, though other implementations can be used as well.

### BRIEF DESCRIPTION OF THE DRAWINGS

FIG. 1 is a conceptual diagram illustrating an overview of a typical ocean fertilization project.

FIG. 2 is a graph showing decrease of downward flux of organic carbon by depth of the water column.

FIG. 3 is a flowchart illustrating a method of assigning quality grades to carbon sequestered via ocean fertilization according to one embodiment of the present invention.

FIG. 4 is a conceptual drawing of an ocean fertilization location illustrating three minimum depth thresholds according to one embodiment of the present invention.

FIG. 5 is a flowchart illustrating a method of identifying carbon stored in accordance with one embodiment of the present invention.

FIG. 6A is a conceptual diagram illustrating an improvement on the typical ocean fertilization project of FIG. 1 including a carbon storage manager according to one embodiment of the present invention.

FIG. 6B is a block diagram showing interaction of the carbon storage manager and database with other entities according to one embodiment of the present invention.

FIG. 7 is a flowchart showing a method of registration and tracking of ocean fertilization project data according to one embodiment of the present invention.

FIG. 8 is a block diagram showing a project tracking database according to one embodiment of the present invention.

FIG. 9 is a high-level block diagram of a computer system according to one embodiment of the present invention.

FIG. 10 is a block diagram of a memory unit of the computer system according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Introduction

The carbon market is a worldwide environmental market that trades the net reduction of a predetermined quantity of carbon dioxide (CO2) from the atmosphere—either by preventing the predetermined quantity such as, e.g., one ton of CO2 that would have otherwise been emitted, or by directly removing a ton of CO2 that is already present. Recent reports have indicated that even drastic reductions in global carbon emissions will not suffice to prevent the increasing severity of global climate change. See generally Pachauri and Reisinger (eds.), Climate Change 2007: Synthesis Report, Contribution of Working Groups I, II and III to the Fourth Assessment Report of the Intergovernmental Panel on Climate Change, IPCC, (2007); and Weaver, A. J. et al. (2007), Long term climate implications of 2050 emission reduction targets, GEOPHYSICAL RESEARCH LETTERS, 34(L19703). The deep ocean is the single largest reservoir of mobile carbon on the planet, and is an appropriate candidate for enhancement through the process of ocean fertilization. Ocean fertilization is an approach that deliberately promotes growth of marine photosynthetic organisms and subsequent CO2 sequestration by the addition to the ocean of one or more elements necessary to their growth.

Stimulating Phytoplankton Blooms

As part of the ocean's “biological pump,” phytoplankton absorb CO2 from ocean water as part of their production of organic matter, which in turn leads to a lower concentration of CO2 in surface waters that causes a concentration gradient favoring uptake of CO2 from the atmosphere. Across the ocean, primary production of phytoplankton is limited by the supply of nutrients essential to their growth cycle, one or more of which is almost always exhausted at some point during the growing cycle. See, e.g., Lampitt et al., Ocean Fertilisation: a potential means of geo-engineering?, Phil. Trans. Roy. Soc. (Jun. 13, 2008). Thus, various means of stimulating phytoplankton with the deliberate addition of nutrients have been proposed as means to trigger long-term carbon storage.

Addition of micro-nutrients. Production of phytoplankton in many ocean regions, e.g., High Nutrient Low Chlorophyll (HNLC) waters, is limited primarily by micro-nutrients, especially iron. Phytoplankton blooms are stimulated naturally by the addition of iron, e.g. when iron-rich sediments are introduced into surface waters. See Blain, S. et al. (2007), Effect of natural iron fertilization on carbon sequestration in the Southern Ocean, Nature, 446(26 April), 1070-1074. In 1988, scientists began investigating ocean iron fertilization (OIF) as a potential carbon mitigation technique. The resulting “Iron Hypothesis” proposed that enhanced iron supply could stimulate greater photosynthesis and thus increased drawdown of atmospheric CO2 via the ocean's “biological pump.” See Martin, J. H., and S. E. Fitzwater (1988), Iron deficiency limits phytoplankton growth in the north-east Pacific subarctic, Nature, 331(6154), 341-343. The biological pump is a process in which a phytoplankton bloom develops and matures over a period of about 60 days, and then falling particles—comprised of dead phytoplankton and fecal matter from organisms that feed on the phytoplankton—aggregate and sink towards the deep ocean, resulting in a transfer of carbon from the atmosphere into the deep ocean. For an explanation of the biological pump and carbon export to the deep ocean as a result, see Ducklow, H. W. et al., Upper ocean carbon export and the biological pump, Oceanography, 14(4): 50-58 (2001). The biological pump can be stimulated by very small amounts of iron (<4 nmol/liter); See Coale, K. H. et al. (1996), A massive phytoplankton bloom induced by an ecosystem-scale iron fertilization experiment in the equatorial Pacific Ocean, Nature, 383(6600), 495-501.

There is good evidence that ocean iron fertilization might sequester large amounts of carbon from the atmosphere. Models of ocean productivity in response to global natural OIF suggest that both biologic productivity and carbon sequestration could increase between 20-30% if iron were no longer in short supply in the most productive regions of the open ocean. See Aumont, O., and L. Bopp, Globalizing results from ocean in situ iron fertilization studies, Global Biogeochem. Cycles, 20 (2006).

Addition of macro-nutrients. In contrast, certain areas of the ocean are Low Nutrient Low Chlorophyll (LNLC) waters characterized by wind-driven downwelling and a strong thermocline, and exhibit very low surface water nutrient concentrations. As a result, in these areas the addition of nitrates, and other nitrogen compounds, phosphates and other phosphorus compounds can be effective to stimulate a phytoplankton bloom which then sequesters carbon.

Artificial upwelling of nutrients through mechanical means. Lovelock and Rapley have proposed pumping deep nutrient-rich water from depths of several hundred meters to the surface to stimulate a phytoplankton bloom. See Biological Ocean Sequestration of CO2 Using Atmocean Upwelling, available at http://www.atmocean.com/sequestration.htm (2007). Nutrients uplifted via upwelling can include both micro and macro nutrients.

Nitrogen fixation. Addition of iron, supported by sufficient local supplies of phosphorus, can be used to stimulate diazotrophic phytoplankton which can “fix” elemental nitrogen into macro-nutrients such as nitrates and other nitrogen compounds. This fixation can create a net carbon sequestration in both deep waters through carbon export.

Quantifying Carbon Storage

Unique nature of the ocean. The ocean is a constantly-moving body. Dissolved components or suspended particles beneath the surface mixed layer generally follow a circulation path resulting from thermohaline circulation that has been called the ‘ocean conveyer belt’. This circulation the average path of a water molecule over long periods of time through a pattern known from measurements of ocean properties. This pattern reflects the predominant circulation of mid- to deep water among each of the major seas and ocean basins of the globe. In general, water enters this circulation pattern from the (upper) mixed layer, and moves to a much longer, slower portion of the cycle that takes place at deep water depths below the thermocline layer, where water can take more than 1,000 years to complete a circuit of this circulation path before it returns to the surface and contact with the atmosphere. If a particle or dissolved component sinks into deep waters in certain deepwater source regions it is statistically more likely that the water associated with the particle or component will not enter the mixed layer again for a long period of time.

Scientists have previously discovered that the ‘age’ of water (i.e., the last known time that any given volume of water was previously in contact with the surface) can be roughly determined by various means. For example, measurements can be made of chemical or radioisotope signatures understood to be correlated with known historical events which can provide a calibration of when any volume of water was last in contact with the surface.

One such proxy is the concentration of man-made chlorofluorocarbon molecules (CFCs). CFCs do not react with seawater and are not altered by chemical and biological processes in the ocean. Thus, the depth to which such molecules have penetrated corresponds to the time at which such molecules were introduced into use, approximately 80 years ago. Another such proxy is carbon 14. This isotope generally occurs in rough proportion to other carbon isotopes only when carbon can exchange freely with the atmosphere. When ocean waters are sequestered from the atmosphere the carbon 14 begin to decay to stable isotopes. The amount of carbon 14 left in the water can be used to determine how long it has been since it equilibrated with the atmosphere, or its ‘age.’

The carbon sequestration arising from ocean fertilization has excellent predictability because of this slow and well-defined circulation. Previous data and interpretation can be used to determine the depth at which waters do not remix with the surface. See, e.g., Tokeida et al., Chlorofluorocarbons in the western North Pacific in 1993 and formation of North Pacific intermediate water, J. of Oceanog., 52(4):475-490 (1996). For example, prior data corresponding to isotopic or other tracer analyses or previously-modeled simulations of ocean circulation may be used. Known examples include previous measurements of man-made chlorofluorocarbon molecules or carbon 14 as discussed above. See, e.g., Broecker, Glacial to interglacial changes in ocean chemistry, Progress in Oceanography, 11(2): 151-197 (1982).

Because of the general predictability of ocean circulation at depth, predictions can be made as to the amount of time that will need to pass for water at a particular depth to be circulated in such a way as to again become exposed to the atmosphere. The location (typically measured by latitudinal and longitudinal coordinates) at which water eventually will rise to the surface generally will be remote from the location at which it is found at the particular depth. This is a known and widely-agreed upon characteristic of physical ocean circulation, as understood by modern oceanographers. For example, computer models including General Circulation Models (GCMs) or Ocean Circulation Models (OCMs) can be used to predict how long it will be until water at a particular depth and location will next come into contact with the atmosphere. For example, one exemplary model is the Regional Oceanic Modeling System (ROMS). See Haidviogel et al., Model evaluation experiments in the North Atlantic Basin: Simulations in non-linear terrain-following coordinates, Dyn. Atmos. Oceans, 32: 239-281 (2000); Shchepetkin and McWilliams, The regional ocean modeling system (ROMS): a split-explicit, free-surface, topography-following-coordinate ocean model, Ocean Model., 9:347-404 (2005); Jin, X. et al., The impact on atmospheric CO2 of iron fertilization induced changes in the ocean's biological pump, Biogeosci., 5:385-406 (2008). An example of the prediction of age of bottom waters using such techniques is: Matsumoto, K. (2007), Radiocarbon-based circulation age of the world oceans, Journal of Geophysical Research, 112(C09004). A compilation of easily accessible Ocean and Atmosphere Circulation Modeling Projects can be found at http://stommel.tamu.edu/˜baum/ocean_models.html. These examples are given by way of illustration and not limitation; other models may be used according to various embodiments.

Similarly, prior survey data could be used, such as from those conducted in natural blooms in the central Pacific Ocean at the Hawaii Ocean Time Series (HOT) station, ALOHA, as documented by Benitiz-Nelson et al., as well as three experiments, SAGE, EIFEX, and FEEP, summarized by Boyd et al. See, e.g. Benitez-Nelson et al., A time-series study of particulate matter export in the North Pacific Subtropical Gyre based on 234Th: 238U disequilibrium, Deep-Sea Research Part I, 48(12): 2595-2611 (2001); Boyd et al., (2007) (cited above). Surveys of the physical and chemical variables in the ocean, including man-made tracers, have been carried out several times as part of large internationally coordinated studies, e.g., the World Ocean Circulation Experiment, data for which is available at the world ocean circulation experiment webpage, http://www.noc.soton.ac.uk/OTHERS/woceipo/ipo.html.

Alternatively, the depth associated with one or more predetermined minimum periods of time until ocean water at a known location will be exposed to the atmosphere may be determined de novo at the time of the ocean fertilization project.

Measuring carbon reductions from ocean fertilization is different from measuring other carbon reductions. The primary difference is that for carbon reductions from ocean fertilization, there is no opportunity to return at a later date and verify the existence of the generated reductions after the project has been completed. Contrast forestry-based carbon reductions, in which it is possible for anyone to visit the project in the future and measure the standing biomass of the project. Several other types of other carbon reduction projects allow other means for checking records, logs, bills, and the like to prove that reductions occurred. Thus, it is very important to be able to accurately measure carbon reductions during the project implementation phase, and to ensure the quality of the instrumentation and computer algorithms used.

Measuring stored carbon. There are several factors important to measuring carbon sequestered through ocean fertilization: permanence, comparison to baseline levels of carbon, the various measurement methods used, corrective calculations and measurements of non-carbon data, and verification and assessment of measured values, additionality, and environmental impact.

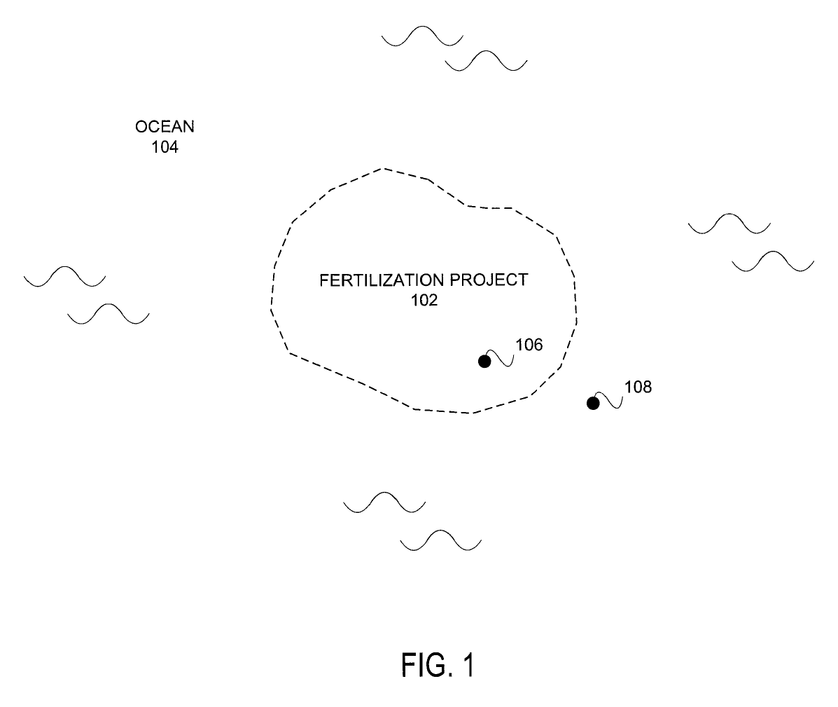

FIG. 1 is a conceptual diagram illustrating an overview of a typical ocean fertilization project. The location of the ocean fertilization project 102 is shown in the ocean 104. The outline is shown in dotted notation because the “shape” and dimensions of the project are constantly moving as discussed above. FIG. 1 is referred to further in the description below.

One measure of the value of carbon reductions is based on “permanence.” Permanence reflects the length of time for which carbon reliably can be said to be removed from the atmosphere. The Intergovernmental Panel on Climate Change (IPCC) explicitly defined the time length period of carbon reductions as a “time horizon.” It recommended to policy makers that a choice be made between 20, 100, and 500 years, upon which all carbon reductions would be normalized. In 1997, the Kyoto Protocol officially recognized one time horizon: 100 years. See Leinen, M., Building relationships between scientists and business in ocean iron fertilization, Marine Ecol. Progress Series, 364:251-256 (July 2008).

However, the IPCC has suggested that policymakers could change the 100 year time horizon for carbon markets commensurate with changing priorities in the fight against global climate change; see Climate Change 1994: Radiative Forcing of Climate Change and an Evaluation of the IPCC IS92 Emission Scenarios, Intergovernmental Panel on Climate Change, Cambridge, U.K. Unlike forestry projects, which have an unknown future spectrum of permanence, the general predictability of the deep ocean circulation as discussed above allows for a known spectrum of permanence periods for carbon credits generated via ocean fertilization. A single ocean fertilization project will generate a spectrum of permanence periods as carbon sinks to various depths, ranging from decades for shallow sinking to a thousand years or millions of years for carbon that sinks into the deep ocean or to ocean floor, respectively. Thus, the time horizon associated with carbon reductions from ocean fertilization projects may be different than, or have additional levels in addition to, the current recognized 100 year time horizon. The methods described herein create a system by which total real carbon reductions are assigned to a permanence time horizon.

Measured carbon reductions are proven to be “real” (a carbon market term) by measuring project parameters against a baseline condition. In addition, corrective factors such as “leakage” and other offsetting factors are subtracted from the total claimed reductions (e.g., the project implementation might require burning fossil fuels to power ships, which generates GHG emissions that would be subtracted from the total claimed carbon reductions). These adjusted reductions then are considered “real.”

Every carbon credit represents a net difference in carbon reductions between the ocean fertilization project and the baseline case of what would have happened in the absence of the project. Measurements begin before the fertilization event to characterize the pre-bloom conditions, and continue at regular intervals through the cessation of the bloom. In addition, projects need to make two sets of measurements for all parameters: one set within the fertilized patch (102), e.g., at a location like 106 in FIG. 1, and one set outside the fertilized patch (102) (a control patch), e.g., at location 108. Then, carbon credits are claimed for the net difference between the measurements. This calculation helps distinguish the effects from ocean fertilization activity from background carbon sequestration resulting from natural low-level phytoplankton blooms at the fertilization location 102. For very large scale ocean fertilization, it may be impractical or impossible to take physical measurements of the baseline condition, and thus the baseline condition will need to be simulated using observations of productivity from sources such as satellite measurements (e.g. SEAWIFS, etc.), in situ observations from moorings, direct measurements, or observation networks (e.g., ARGO float system), modeling, and prior research results.

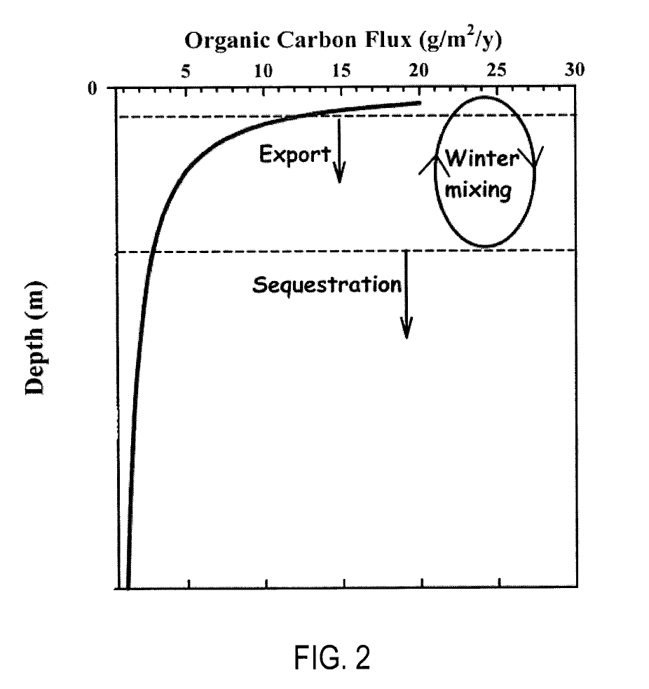

Several different types of carbon exist in the ocean. Biological production generates either Particulate Inorganic Carbon (PIC) (e.g., calcium carbonate) or Particulate Organic Carbon (POC), which have significantly differing CO2 uptake. Most synthesized POC is remineralized to Dissolved Inorganic Carbon (DIC) in the top few hundred meters of the ocean, but some escapes to lower depths and thus is considered sequestered. FIG. 2 shows the modeled decrease of downward flux of organic carbon by depth of the water column (this example (after Lampitt, R. S. et al. (2008), Ocean Fertilisation: a potential means of geo-engineering?, Philosophical Transactions of the Royal Society A, 366(1882), 3919-3945) is from the temperate North Atlantic Ocean).

Measurement of POC flux typically is via the use of sediment traps that intercept the sinking particles in containers that contain preservatives to prevent decay and/or degradation of the POC. The sampling cups on the traps contain hypersaline solution with formalin and mercuric chloride. Material that falls in the cups is trapped in the dense saline solution and is preserved from decay. Larger (˜1 cm) organisms that swim into the traps and are captured are easily recognized in the material and are removed. The material is filtered, dried, and analyzed for carbon content. Early experiments used sediment traps tethered to surface buoys, but later projects have used untethered neutrally buoyant traps that are adjusted to remain at specific depths in the water. See, e.g., Buesseler, K. O. et al., Revisiting Carbon Flux Through the Ocean's Twilight Zone, Science, 316(5824):567-570 (2007).

Alternatively, deep water pump technology or transmissometer technology may be used to measure POC. Another approach is to collect samples of water at various depths using a hyrdrocast rosette system (or other sampling method) to measure carbon system parameters such as dissolved organic carbon (DOC) and dissolved inorganic carbon (DIC). This technique can quantify carbon sequestration that occurs in dissolved form rather than in particulate form.

Although sediment trap fluxes are generally viewed as the best and/or key measurement of particulate carbon flux, several other measurements are useful to supplement and amplify the information from the trap fluxes. It is desirable to constrain as many components of the carbon system as possible during observations of the result of iron fertilization.

Measurement timing intervals vary widely depending on the nature of the measurement (e.g., hours to days to weeks). Most of the carbon sinks after the maturation of the phytoplankton bloom, and this carbon can sink relatively quickly so little will be missed as long as the measurements are conducted past the bloom termination. However, in some instances modeling can be useful to correct for carbon sequestration that is not directly observed.

The accuracy of these measurements are directly related to an observer's ability to obtaining accurate estimates of carbon sequestered. The use of independent measures of carbon sequestration via particle fluxes from sediment traps, from pumps, transmissometry, and/or thorium-234 measurements, and from carbon system parameter measurements provide independent checks on the validity of the measurements beyond the simple analytical accuracy of the result.

Likewise, while measurements of sinking carbon flux are a first approximation for actual reductions in atmospheric CO2, a correction can be implemented to improve the accuracy of quantified carbon reductions. Some of the carbon that is taken up by phytoplankton after fertilization could be replaced by dissolved carbon from adjacent regions of the ocean instead of being replaced by atmospheric CO2. E.g., one researcher used models showing that roughly 80-90% of the deepwater carbon export is replaced by atmospheric CO2, thus net claimed carbon credits in this example would be reduced by 10-20%. Jin, X. et al., The impact on atmospheric CO2 of iron fertilization induced changes in the ocean's biological pump, Biogeosciences, 5:385-406 (2008). The calculation of the Air-Sea CO2 Flux Fraction requires a combination of modeling and in situ measurements.

Other carbon system parameters that are generally measured to calculate a net sequestration value include the Dissolved Organic Carbon (DOC), Dissolved Inorganic Carbon (DIC), and atmospheric CO2. The change in DIC with time reflects a combination of conversion of DIC to POC and PIC during photosynthesis, release of DOC into the water from excretion and lysing of dead cells, and the uptake of CO2 from the atmosphere.

For a given permanence time horizon, the net carbon sequestration can be calculated as follows: [[({DOC+DIC final}−{DOC+DIC initial} inside)−({DOC+DIC final}−{DOC+DIC initial} outside)]+[({POC+PIC final}−{POC+PIC initial} inside)−({POC+PIC final}−{POC+PIC initial} outside)]×(Air-sea CO2 flux corrections)−(other radiatively active gases)−(CO2 emitted from fossil fuel use during experiment)], where inside (FIG. 1, 106) and outside (108) refer to values obtained inside and outside the fertilization project area 104 at the depth associated with the specified permanence time horizon, and where initial and final refer to conditions before and after the project implementation phase. The data for these calculations are obtained from in situ measurements before, during, and after the fertilization project, and from both pre- and post-computer modeling. In the practice of the carbon market, the calculations of net carbon sequestration arising from the project can be more complex, and agenerally are described using a formal methodology document that explicitly details all calculations used. This methodology document provides the basis for third party review of data and calculations that allow carbon reductions to be certified and registered for sale in the carbon market.

Measurements of non-carbon data also can affect the net effects of the ocean fertilization project, including measurements of offsetting radiatively active greenhouse gases that can be produced by the process of ocean fertilization through microbial respiration of sinking organic material. In these embodiments, measurements are made of compounds, such as nitrous oxide (N2O), methane (CH4), or other greenhouse gases generated during the bloom process using various known methods (e.g., systems including gas chromatography for measuring atmospheric and dissolved N2O and CH4 in surface waters, etc.). The carbon dioxide equivalent of these greenhouse gases is subtracted from the carbon dioxide sequestered.

Similar to the carbon measurements, measurements of N2O, CH4, or other biogenic gases can be made separately in both the project patch (FIG. 1, 106) and the control patch (108). These measurements can be taken in the surface mixed layer and at depths where carbon is sequestered. The difference in total biogenic gas production between the project (106) and control patch (108) yields the net biogenic gas production for a depth, and this value can be used to correct the total claimed carbon reductions for a depth. For example, if 10,000 tons net of CO2 are sequestered at a given depth (e.g., below 50 m), and 2 tons net of N2O gas is produced at the same depth, then 600 tons of CO2 (N2O has a global warming potential value of 300 times CO2) is subtracted from the total claimed carbon sequestration for that depth. Finally, the production of biogenic gases can be modeled using general circulation models, and modeling results can be used to adjust the data from physical measurements during the project implementation phase.

In some embodiments, another radiatively active gas dimethyl sulfide (DMS), which can be generated by the phytoplankton bloom, is also measured using known systems for taking water samples, air samples and other DMS measurements. DMS generated has been shown to interact in the atmosphere to increase cloudiness, and therefore to increase albedo (percentage of solar energy reflected back to space by a surface), which can cause environmental cooling. Thus, the DMS generated can also be taken into account when determining carbon storage. More specifically, carbon credits can be claimed from radiative forcing reductions from DMS production as a result of OF. The IPCC standard normalizes all carbon credits to the total radiative forcing of carbon dioxide with a 100 year atmospheric lifetime and thus the radiative forcing reduction benefit of DMS can be converted to a CO2 reduction equivalent using IPCC Global Warming Potential (GWP) calculations. See IPCC, Climate Change 1994: Radiative Forcing of Climate Change and an Evaluation of the IPCC IS92 Emission Scenarios, Intergovernmental Panel on Climate Change, Cambridge, U.K. (1995).

GWP calculations work as follows. Starting with the cumulative lifetime radiative forcing effect of the greenhouse gas, it is divided by (under the current IPCC standard) one ton of CO2 with a 100 year time horizon. The resulting ratio is the GWP value of the gas. For example, one ton of methane, which has a very short lifetime compared to CO2, has a carbon credit value 23 times greater than 1 ton of CO2 because its lifetime radiative forcing is 23 times greater than 100 years of radiative forcing from 1 ton of CO2. By multiplying one ton of the (non-CO2) gas by its GWP, the warming effect is converted to the CO2-equivalent (or “CO2e”), and is used to make effective comparisons of greenhouse gas reduction measures that span multiple greenhouse gases. By direct analogy, the total radiative forcing benefit of DMS production can be normalized against the same standard (e.g. CO2 for 100 years) and thus produce a quantity of tons of carbon dioxide equivalent. This quantity may be added to the total carbon sequestered by the project for at least 100 years.

Certain verification measures also can to take place with respect to the carbon reductions. Among these are one or more additionality tests, which determine whether the project results would have happened anyway in the absence of the carbon market. Examples of this are the “financial additionality test” (which determines whether the project is financially feasible in the absence of carbon credits), the “regulatory additionality test” (which determines whether the project is required by some external non-carbon regulation), and the “common practice additionality test” (which determines whether the project would have occurred anyway through established common practices). These tests and others are defined in Trexler, M. C. et al., A statistically-driven approach to offset-based GHG additionality determinations: what can we learn?, Sustainable Development Law and Policy, VI(2): 30-40 (2006). These additionality tests may require one or more separate additionality methodologies that define a quantifiable procedure to prove additionality (e.g., the CDM Additionality Tool, available at http://cdm.unfccc.int/methodologies/PAmethodologies/AdditionalityTools/Additionality_tool.pdf).

In addition, all certified offsets have their existence verified by an independent third party. This would be verification of the measurements and models that were used to demonstrate sequestration. The verification may take place during the project implementation phase, and also at any subsequent time by examining data and records from the project.

Ocean fertilization projects also can assess the environmental effects of the project. Environmental effects include the production of biogenic gases, the consumption of oxygen, changes in sea water pH, the consumption of nutrients, changes to biologic productivity, changes to species diversity, potential for Harmful Algal Blooms, and any other harmful effects.

The generation of carbon reductions that have value on the carbon market is generally captured in a methodology document that explicitly defines the quantifying carbon reductions and dealing with other issues described above (e.g. additionality, environmental effects, etc.). Depending on the type of ocean fertilization project, the exact calculations and procedures for measurement and modeling will be different, however, the process of generating carbon reductions of any specified time horizon will be the same. First, the methodology for carbon reduction quantification is generated and often openly published for third party review. Second, the project is implemented and measurements of carbon sequestration and other factors are taken as explicitly described in the methodology. Third, the combination of the methodology document and the final published data from the project allow net carbon reductions to be calculated, and also allow an independent third-party “Verification Entity” to verify the amount of net carbon reductions claimed by the project developer. This formal process of methodology, project implementation, and verification gives carbon reductions value in carbon markets, because their existence can be both certified by a standards body and entered into a carbon reduction registry. For a general overview of the methodology process, See World Business Council for Sustainable Development (WBCSD) and World Resources Institute (2005), “Greenhouse Gas Protocol: The GHG Protocol for Project Accounting”, ISBN 1-56973-598-0, http://pdf.wri.org/ghg_project_accounting.pdf.

### Inventive Methods

Carbon Grading

As discussed above, ocean fertilization projects are unique from other carbon reduction projects because they generate a permanence spectrum of carbon reductions depending on the depth distribution of sequestered carbon. As a result, a permanence spectrum can be established, and for measured carbon at those depths, grades can be assigned.

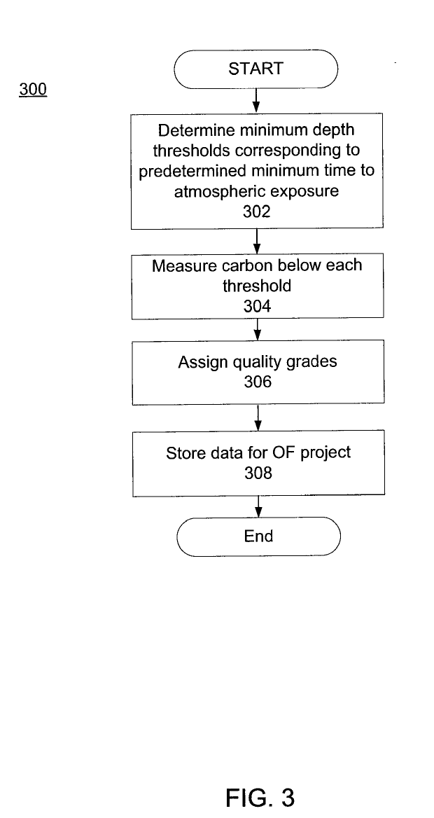

FIG. 3 is a flowchart 300 illustrating a method of assigning quality grades to carbon sequestered via ocean fertilization according to one embodiment of the present invention.

The method begins with determining 302 a series of minimum depth thresholds for sequestered carbon as part of an ocean fertilization project, each threshold corresponding to a minimum time until which ocean water at that depth will be exposed to the atmosphere.

The predetermined minimum periods of time may correspond to specific standards set by a standards body, e.g., by the IPCC, which recommended multiple “time horizons” upon which to normalize the effectiveness of various carbon mitigation strategies, and the United Nations Framework Convention on Climate Change (UNFCCC), which chose 100 years as the time horizon standard for the Kyoto Protocol. For example, the predetermined minimum periods of time may be 20 years, 100 years, 500 years, or 1,000 years, or in the case of deposition of particles to the seafloor, 100,000 years or longer. These exemplary minimum time horizons are not meant to be limiting; standards bodies and frameworks may use different lengths of time according to changing priorities for short or long term carbon reduction benefits.

Depths associated with various time horizons can vary considerably by region in the ocean, and thus the depths established should be specific to a particular location, e.g., associated with an ocean fertilization project. Since the location is known, and due to the predictability of the ocean as described above, time-depth permanence correlations may be estimated using values previously determined for the area of the ocean, or may be determined de novo for a fertilization location using empirical data (e.g., analyses of isotopic or other tracer molecules) or in silico (e.g., using GCM or OCM computer modeling).

In one embodiment, the modeling takes place prior to the ocean fertilization project implementation. In practice, the specific depths 402-406 for any particular ocean fertilization project can be determined through the application of a general ocean circulation model (GCM) to simulate the time-depth dependence specific to the location of the project. For example, if a project was planned to take place in the Southern Ocean (e.g., coordinates of 55S 120W), a GCM can be used to model the time-until-surfacing for all depths below the fertilized patch. Then the depths 402-406 would be chosen to correspond to each desired time period (e.g., 100 years might correspond to 500 m depth, 1,000 years might correspond to 2,500 m depth, etc.).

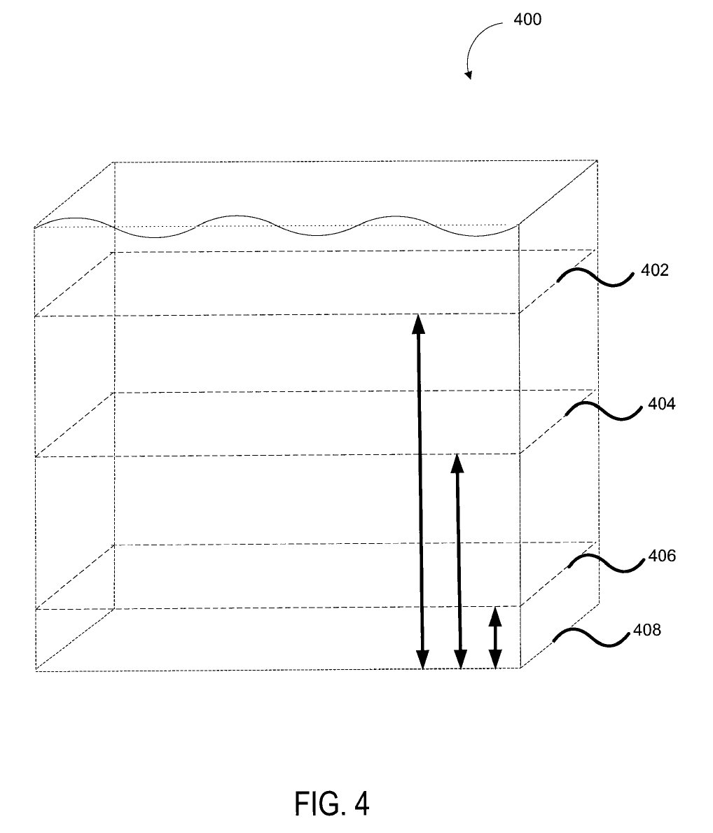

FIG. 4 is a conceptual drawing of a ocean fertilization location 400 illustrating three minimum depth thresholds 402-406 according to one embodiment of the present invention. Through pre-project modeling, depths associated with a particular set of time horizons would be determined 302, and a set of minimum depth thresholds 402-406 associated with them.

Next, the amount of carbon exported past one or more of the depth thresholds 402-406 can be measured 304, and from a series of measurements, the total mass of carbon exported past the depth thresholds 402-406 can be calculated for the entire fertilization area. The measurements can use any of the above-described measurement methodologies, baseline comparisons, corrective and non-carbon calculations, and verification/assessment mechanisms. In addition, any other measurement tool or technique can be used that provides an accurate measurement.

The above measurement methodologies can be used in conjunction with seagliders and sensor array technologies to provide a more accurate export image by measuring the actual boundary of the exported carbon flux at depth instead of simply inputting it from the initial seeding area at the surface. Seagliders are free-swimming Autonomous Underwater Vehicles (AUVs) that travel through the water, and that can gather conductivity, temperature, depth, and other data from the ocean for periods of time (e.g., months), and can transmit this information to outside computers or devices, e.g., on the shore using satellite telemetry or other methods.

Quality grades are assigned 306 to carbon measured below each depth threshold 402-406. A number of quality grades associated with sequestered carbon can be established by this method, in which carbon that is removed for a longer period of time is considered to be of a “higher” grade. The different grades then may be sold in the carbon market for different prices.

Finally, the carbon grade information and other data is stored 308 in a quality grade database. In order for monetary value of the credits to be realized, according to one embodiment the data is transmitted to a registry.

In some embodiments, certain flux corrections can be made to obtain a more accurate grade assignment. For example, carbon flux measured at deeper (older) time-depths is removed from the amount calculated from the adjacent shallower (more recent) time-depths to avoid double counting of the amount of sequestered carbon. Table 1 below illustrates an example.

Assume measurements are made that allow carbon flux determinations through volumes of water past depth thresholds 402-406 corresponding to sequestration for less than 100 years (1 year carbon), and for between 100 and 500 years (100 year carbon). Referring to FIG. 4, these depth ranges would correlate to, e.g., 402 and 404, respectively. Assume further that the tons of carbon fluxing through each depth are as shown in Table 1.

TABLE 1
Flux observations at two time-depths

| | Observed Flux | Corrected Flux | Price/ton | Proceeds |
|---|---|---|---|---|
| Time-depth | (tons) | (tons) | ($/ton) | ($) |
| <100 yrs (1 yr) | 15 | 7 | 0 | 0 |
| 100-500 yrs | 8 | 8 | 10 | 80 |
| (100 yr) | | | | |
| Total | | | | 80 |

In this example, the total amount of carbon fixed following the ocean fertilization is 15 tons, of which 7 tons is associated with the <100 years (i.e., 1 year) quality grade, and 8 tons is associated with the 100-500 years (i.e., 100 year) quality grade.

This method produces quality grades associated with a carbon time horizon, in which the carbon exported past the threshold is sequestered for at least as long as the classified grade, i.e., the 1 year quality grade remains sequestered for at least 1 year, and the 100 year quality grade remains sequestered for at least 100 years. It is inherent that virtually all of the carbon will be stored for longer time periods than the threshold, because a depth range will be identified that will include carbon that, because it is deeper than the upper level of the depth range, is likely to remain sequestered longer. Once carbon has been sequestered into waters that will not be exposed to the atmosphere for more than 100 years, there is also some likelihood that it will sink deeper and be sequestered for even longer.

The measurement accuracy for the sequestered carbon pool can be improved through two approaches. In the first approach, additional flux measurements are made at increasing depths so as to more accurately characterize the time-permanence of the sequestered carbon pool. Table 2 provides an illustration of this approach.

TABLE 2
Flux observations at four time-depths

| | Observed | Corrected | | |
|---|---|---|---|---|
| | Flux | Flux | Price/ton | Proceeds |
| Time-depth | (tons) | (tons) | ($/ton) | ($) |
| <100 yrs (1 yr) | 15 | 7 | 0 | 0 |
| 100-500 yrs (100 yr) | 8 | 5 | 10 | 50 |
| 500-1,000 yrs (500 yr) | 3 | 2 | 50 | 100 |
| 1,000-1,000,000 yrs | 1 | 1 | 100 | 100 |
| (1,000 yr) | | | | |
| Total | | | | 250 |

In the example, the total amount of carbon fixed following the ocean fertilization is the same 15 tons as in the example of Table 1. However, additional flux measures are taken at depths corresponding to quality grades of 500 years and 1,000 years. Referring again to FIG. 4, these would be 406 and 408 (sea floor). With these additional flux observations, it is possible to calculate that of the 15 tons of carbon fixed by the algal bloom resulting from the fertilization, 7 tons is associated with the <100 year (i.e., 1 year) quality grade, 5 tons is associated with the 100-500 years (i.e., 100 year) quality grade, 2 tons is associated with the 500-1,000 years (i.e., 500 year) quality grade, and 1 ton is associated with the 1,000-1,000,000 years (i.e., 1,000 year) quality grade. Thus, instead of allocating 7 tons to the 1 year grade, and 8 tons to the 100 year grade (as shown in Table 1), the lot is more accurately characterized to reflect 7 tons in the 1 year grade, 5 tons in the 100 year grade, 2 tons in the 500 year grade, and 1 ton in the 1,000 year grade. The additional observations increase the realization for the project from $80 (Table 1) to $250 (Table 2).

A second approach is to calculate sequestered carbon on a mean or average basis. Volume productivity of a project area for a certain time classification (i.e., 1,000 year carbon) can be calculated by integrating the carbon observed to be exported across an optionally more finely graded depth sampling to effectively calculate an average time permanence for the whole lot. This permits some carbon which previously lay above a given threshold time-depth to be averaged with longer time permanence carbon below to provide an aggregated mean or average. This is the “ton-year” approach to quantifying carbon credits. This approach was discussed in detail by the IPCC in regard to forestry. See IPCC, Land Use, Land-Use Change, and Forestry, edited by R. T. Watson et al., Intergovernmental Panel on Climate Change, Cambridge, U.K., p. 87 (2000). For the example set forth in Table 2, we can calculate an average time permanence as shown in Table 3.

TABLE 3
Average time permanence based on flux
observations at four time-depths

| | Observed | Corrected | | Fractional |
|---|---|---|---|---|
| | Flux | Flux | Fractional | yield × |
| Time-depth | (tons) | (tons) | yield | time-depth |
| <100 yrs (1 yr) | 15 | 7 | 0.47 | 0.47 |
| 100-500 yrs (100 yr) | 8 | 5 | 0.33 | 33 |
| 500-1,000 yrs (500 yr) | 3 | 2 | 0.13 | 65 |
| 1,000-1,000,000 yrs | 1 | 1 | 0.07 | 70 |
| (1,000 yr) | | | | |
| Total | | 15 | 1.00 | 168.47 |

Thus, in the example illustrated in Table 3, the 15 ton lot of carbon produced by ocean fertilization is sequestered for an average length of time of 168.5 years. An advantage of this approach is that it allows some carbon which previously lay above a given threshold time-depth (i.e., the <100 years) to be averaged with longer time permanence carbon below to provide an aggregated mean or average. Assuming the price in the carbon market for one ton of stored carbon is $0.1/ton-year of time-permanence for thresholds above 100 years, the approach illustrated in Table 3 increases the realization of the project to 15 tons×16.85 $/ton-year=$252.75.

Identifying Stored Carbon

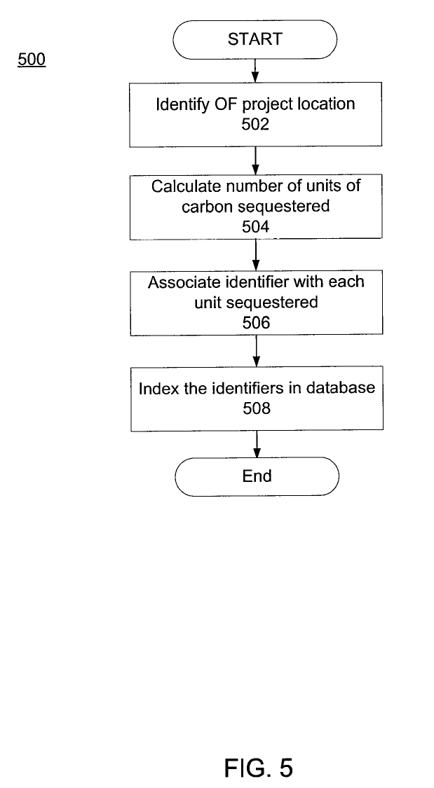

Referring now to FIG. 5, a flowchart 500 is shown illustrating a method of identifying carbon stored in accordance with one embodiment of the present invention.

The method begins by identifying 502 an ocean iron fertilization project location comprising a volume of ocean water in which carbon has been sequestered. The location is defined according to one embodiment, by latitude and longitude coordinates around the perimeter of the location, as well as depth information. In another embodiment, the coordinates of the center point are defined, combined with three-dimensional distances from the center. The shape and size of the fertilization location can be determined by various means known in the art, and/or methods described herein.

The fertilization location information can include global positioning system (GPS) coordinates of a particular section of the ocean or other location information, size of the area, temperature, etc. The information received also can include details regarding the fertilization activity conducted at the fertilization area, including when and how long, and what types of fertilization activity occurred, fertilization location size (e.g., area, volume, etc.), measurements taken by ship or ocean instruments during the fertilization activity, historical data (e.g., data regarding the location, regarding other fertilization activity at the location, fertilization data in general, etc.), and so forth.

Once the project location and amount of carbon sequestered are known, the total carbon sequestered at the fertilization location is calculated 504 as predetermined mass units (e.g., tons) of carbon storage. The portion of the fertilization location corresponding to a ton of carbon may be an irregular shape, and may change over time. The calculated predetermined mass units may be sectioned by their corresponding time horizon, if any is measured, either before of after the calculation is made. The predetermined mass units of carbon may be the net effect of all aspects of the measurements, such as including consideration of biogenic gases, dissolved oxygen, pH, and ecological effects. In some instances, the bloom will not have an even number of predetermined mass units of carbon sequestered, and thus the number may include a decimal or fraction of a ton.

Next, an identifier is associated 506 with each of the tons of carbon stored. The identifiers are unique and act as reference numbers for tracking of the segments. The unique identifier can be any numeric string or serial number, an alphanumeric string, a string including spaces and punctuation, hexadecimal code, a checksum, a hash value, or some other type of identifier. The identifier in the same or a different form can be used for tracking entire lots or many tons of CO₂ or carbon, e.g., by an identifier corresponding to a group of predetermined mass units or an entire fertilization location project. In an alternative embodiment, multiple identifiers are assigned to each ton of stored carbon.

The identifiers then are indexed 508 in a database. The unique identifier can provide various additional information about the associated ton of carbon according to one embodiment, e.g., amount of time for which the ton of carbon is sequestered, location and depth information, price, bloom location, bloom seeding date and time, ocean parameters such as conductivity, temperature, chemistry, depth, etc., images of the bloom, biological character of the bloom, general information about carbon storage via iron fertilization, and so forth. This information may be received from the fertilization project location, e.g., transmitted from seagliders using satellite data telemetry or the like. The identifier itself may include some of the information, or can be used as a link to locate additional information about the segment (e.g., within a database, from on a particular website, etc.).

Carbon Storage Management

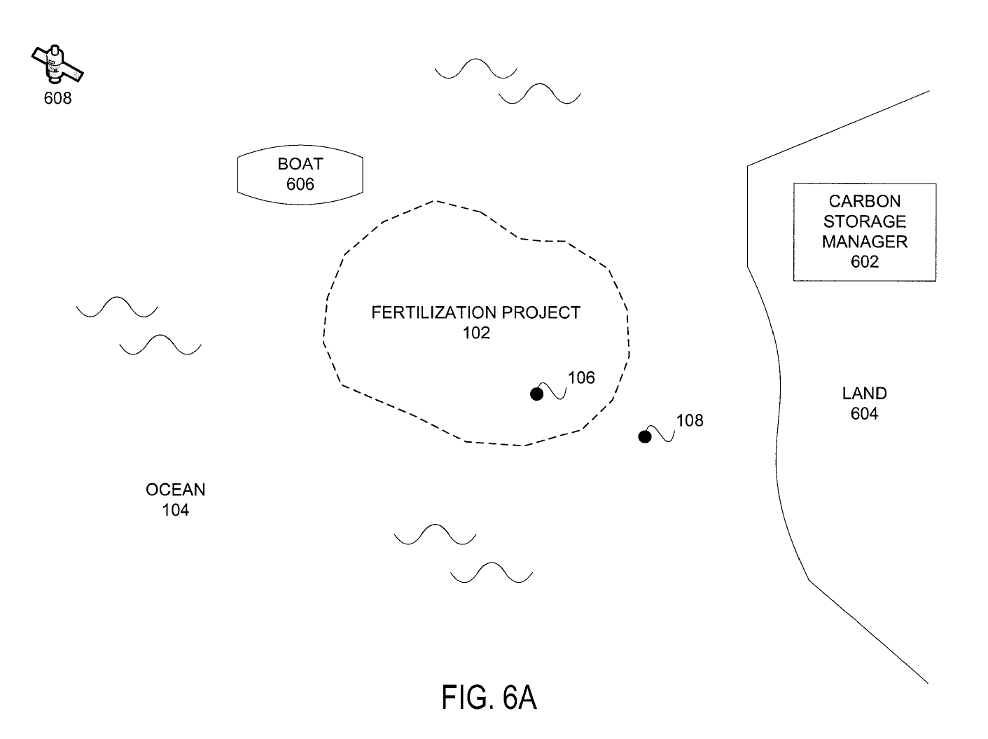

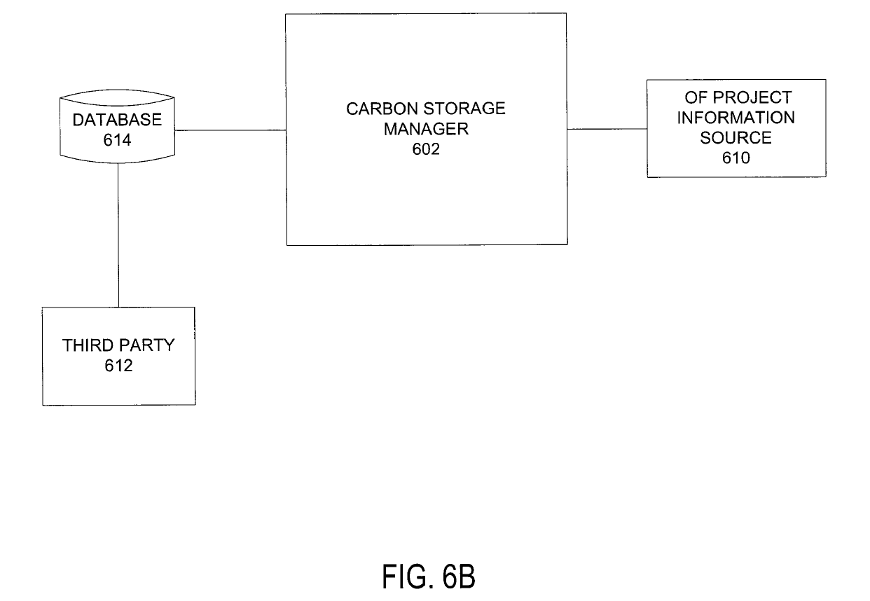

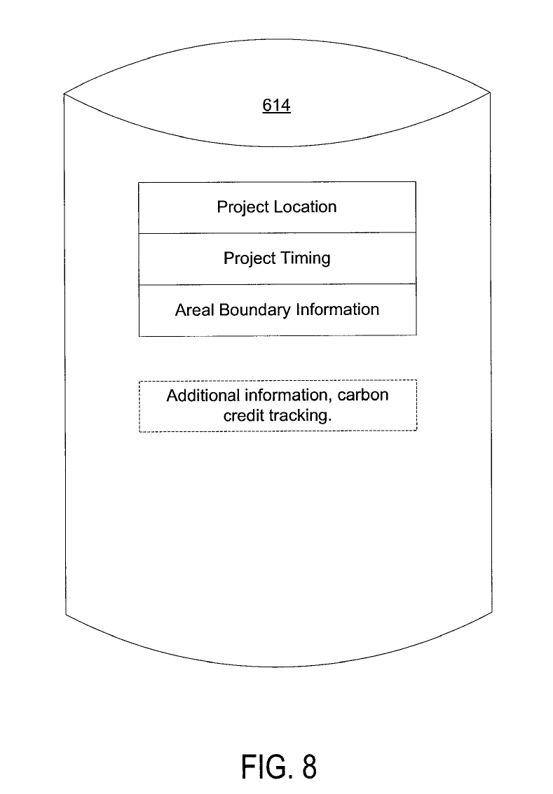

Carbon reductions arising from ocean fertilization are stored deep in the ocean and move with the water mass with which they are associated. Thus they are indistinguishable from carbon stored by other means. Therefore, the only means of verification is to use a comprehensive database of all data necessary to calculate carbon reductions, to predict the timing and location of downstream effects, and assign these effects to a specific project. Such a database is described in conjunction with FIGS. 6B and 8. Downstream effects refer to changes caused by the project that occur at some time after the project implementation phase, as ocean water associated with the project circulates, undergoes further biogeochemical reactions, and comes into contact with water in other regions. These downstream effects include carbon storage, biogenic gas production, oxygen depletion, changes to pH, changes to available inorganic nutrients, changes to organic biomass. All independent verifiers of ocean fertilization projects will need to use the data stored in the registry.

FIG. 6A is a conceptual diagram illustrating an improvement on the typical ocean fertilization project of FIG. 1 including a carbon storage manager 602 according to one embodiment of the present invention. The carbon storage manager 602 enables the methods described herein, manages a database for ocean fertilization project information, and coordinates various ocean fertilization projects. The carbon storage manager 602 exists on, and performed its functions on, land 604, e.g., on United States soil. Also shown in FIG. 6A is a boat 606 associated with the fertilization project 102, as well as satellite 608 for transmitting telemetry information from the fertilization project 102 or boat 606 to the carbon storage manager 602.

FIG. 6B is a block diagram showing interaction of the carbon storage manager 602 and database 614 with other entities 610, 612. The database 614 is used to store ocean fertilization project information for multiple ocean fertilization projects, as further described in conjunction with FIG. 8.

Ocean fertilization project information sources 610, such as boats 606, instruments, people or organizations associated with an ocean fertilization project provide various information about proposed, in progress, or completed ocean fertilization projects for storage in database 614. These data may include location information, telemetry associated with the project, data collection methods, ownership information, additionality information, verification information, environmental impact information, sustainable development information, environmental justice information, downstream effects, oceanographic models information, and any data from the above-described methods.

Third parties 612 desiring access to the database 614 may include future ocean fertilization project coordinators seeking access to information about locations being considered for a proposed ocean fertilization project, independent verifiers of the carbon storage information, standards or governing bodies, or other interested parties desiring access to the data stored therein.

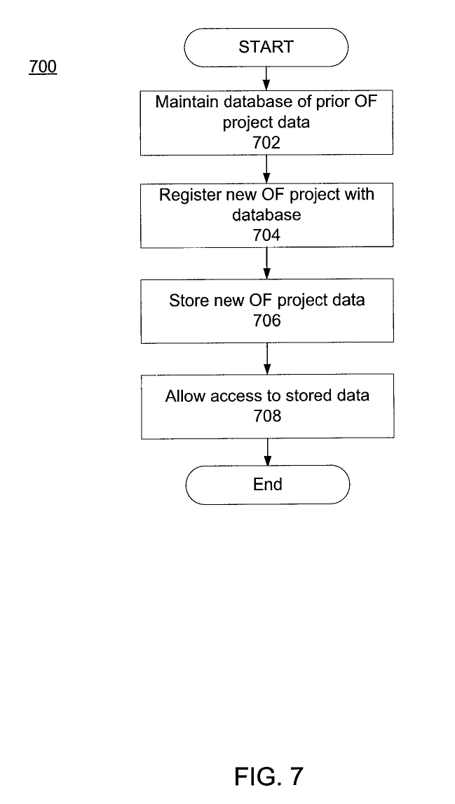

FIG. 7 is a flowchart 700 showing a method of registration and tracking of ocean fertilization project data according to one embodiment of the present invention.

The method begins with maintaining 702 a project tracking database including stored data for prior ocean fertilization projects. The project tracking database may be database 614, and includes, at minimum, information about the project location, timing, and the areal extent or boundary of the project. In addition, the project tracking database may include project description information (e.g. type of fertilization), project ownership, financial details, carbon sequestration measurement data and methodology, modeling results, record of available carbon credits, record of purchased carbon credits, legal status (e.g. permits under relevant regulatory frameworks), environmental effects (including ‘downstream’ and future effects), and environmental impact statements.

Next, new ocean fertilization projects are registered 704 with the database 614 before execution. Registration allows the future project coordinators access to database information for purposes of coordinating potential locations for the new ocean fertilization project, and for accessing data stored about the prior fertilization projects and their downstream effects.

When the project is executed, the new ocean fertilization project data also is stored 706 in the database 614. Through various means, access may be allowed 708 to the database 614 or portions of the data contained therein, e.g., for project coordination purposes as discussed above. In addition, third parties 612, such as verifiers of carbon storage and others also may be provided access to some or all of the stored data. Various interfaces may be provided to the user, including a web interface.

FIG. 8 is a block diagram showing a project tracking database 614 according to one embodiment of the present invention.

According to one embodiment, the database 614 is used for project coordination, and thus stores at least information about the project location, timing, and the areal extent or boundary of the project for use in determining where next to put an OF project, In addition, the project tracking database may include additional project description information (e.g., ownership, type of fertilization), record of available carbon credits, record of purchased carbon credits, legal status (e.g. permits under relevant regulatory frameworks), environmental effects, carbon sequestration measurement methodology, and any other data necessary to quantify carbon sequestration.

In addition, the database 614 may store data collection methods, identifiers, multiple permanence levels, additionality information, verification information, environmental impact information, and oceanographic models information as described above.

The database 614 also may include geographic and physical parameters such as location and other parameters to prevent overlapping fertilization projects or downstream effects and to assess jurisdiction issues.

The database 614 may include details on environmental impacts, such as the creation of biogenic gases, the depletion of oxygen, changes to pH, harmful algal blooms, changes to species composition and diversity, and changes to levels of nutrients in waters. This information may be stored as individual data, or collected in formal environmental impact assessment documents.

The database 614 may include ownership information. All reductions must have a clear path of ownership, so that the sale and transfer of credits can be legally established. Ownership can be function of financial responsibility, legally binding agreements, and the physical location of the project within a particular jurisdiction or sovereign territory.

The database 614 may include sustainable development information. If an ocean fertilization project assesses benefits toward the sustainable development of communities associated with the project (e.g., benefits to fisheries as a result of increased phytoplankton at the base of the food web), this information can be tracked in the database 614.

The database 614 may include environmental justice information. Despite having positive environmental benefits in one location, an ocean fertilization project may have negative effects on some other location. Information regarding these effects can be tracked in the database 614.

The database 614 may include information regarding cumulative downstream effects of the project. By directly incorporating both oceanographic models and the raw data from projects into the database 614, it is possible to track and predict cumulative downstream effects at any future time or place as a result ocean fertilization projects conducted at any time or place in the ocean. This allows regulators and policy makers to balance both present and future positive and negative effects, and thereby make policy decisions on the “safe” and “effective” level of large scale (e.g., sizes approaching entire ocean basins) and long term (e.g., decades to centuries) ocean fertilization. This information also allows for real-time adjustments of these levels based on the cumulative data collected throughout any ocean fertilization project entered in the registry.

### Carbon Storage Manager Architecture

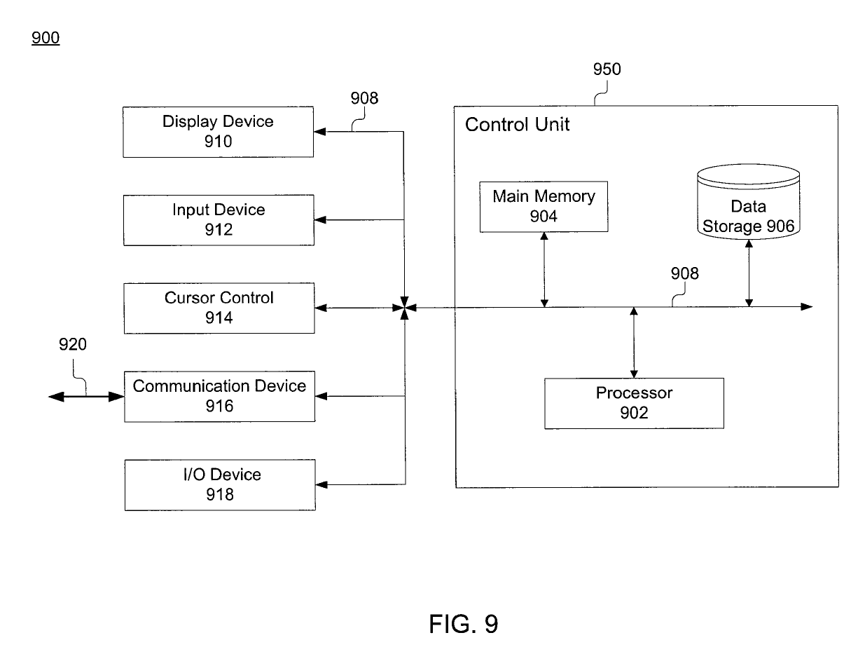

In one embodiment, the systems and methods described above can be implemented by a computer. Referring to FIG. 9, there is shown a high-level block diagram of a computer system 900 for implementing the method described above according to one embodiment of the present invention. The computer system 900 can act as a client computer, a server, etc. Illustrated is a control unit 950, which includes a processor 902, a main memory 904, and a data storage 906 coupled to a bus 908. Also coupled to the bus 908 are a display device 910, an input device such as, e.g., a keyboard 912, a cursor control 914, a communication device 916, and an I/O device 918.

The processor 902 may be any general-purpose processor such as an INTEL x86, SUN MICROSYSTEMS SPARC, or POWERPC compatible-CPU, or the processor 902 may also be a custom-built processor. Processor 902 processes data signals and may comprise various computing architectures including a complex instruction set computer (CISC) architecture, a reduced instruction set computer (RISC) architecture, or an architecture implementing a combination of instruction sets. Although only a single processor is shown in FIG. 9, multiple processors may be included.

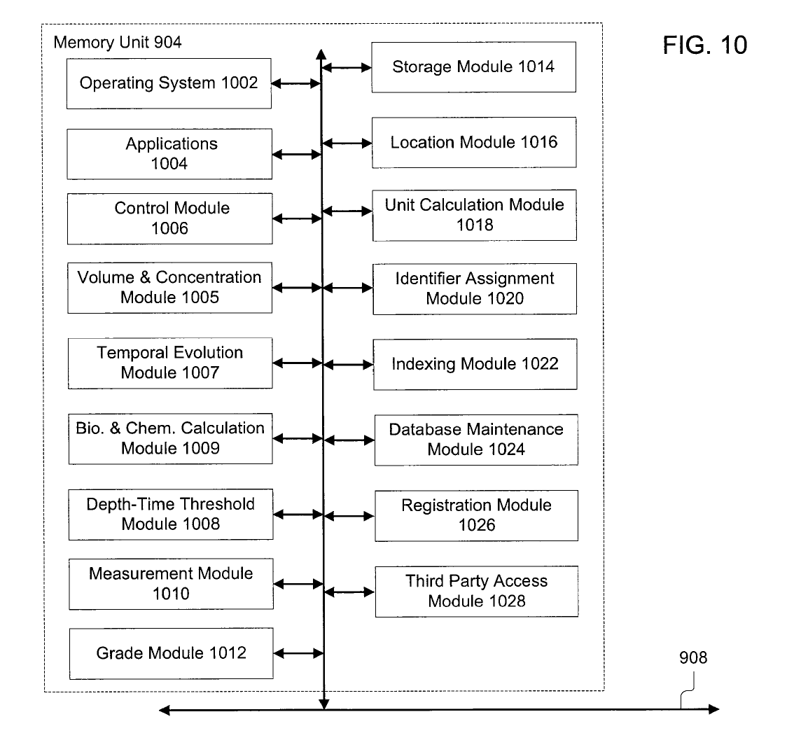

Main memory 904 stores instructions and/or data that may be executed by processor 902. The instructions and/or data may comprise code for performing any and/or all of the techniques described herein. Main memory 904 may be a dynamic random access memory (DRAM) device, a static random access memory (SRAM) device, or some other memory device known in the art. The memory 904 is described in more detail below with reference to FIG. 10. All or some of the contents of the memory 904 may be housed on a computer-readable storage medium.

Data storage device 906 stores data and instructions for processor 902 and comprises one or more devices including a hard disk drive, a floppy disk drive, a CD-ROM device, a DVD-ROM device, a DVD-RAM device, a DVD-RW device, a flash memory device, or some other mass storage device known in the art. In one embodiment, data storage device 906 includes database 614. System bus 908 represents a shared bus for communicating information and data throughout control unit 950. System bus 08 may represent one or more buses including an industry standard architecture (ISA) bus, a peripheral component interconnect (PCI) bus, a universal serial bus (USB), or some other bus known in the art to provide similar functionality. Additional components coupled to control unit 950 through system bus 908 include the display device 910, the input device 912, cursor control 914, the communication device 916 and the I/O device(s) 918.

Display device 910 represents any device equipped to display electronic images and data as described herein. In one embodiment, the display device 910 is a liquid crystal display (LCD) and light emitting diodes (LEDs) to provide status feedback, operation settings and other information to the user. In other embodiments, the display device 910 may be, for example, a cathode ray tube (CRT) or any other similarly-equipped display device, screen, or monitor.

In one embodiment, the input device 912 is a keyboard. The keyboard can be a QWERTY keyboard, a key pad, or representations of such created on a touch screen. Cursor control 914 represents a user input device equipped to communicate positional data as well as command selections to processor 902. Cursor control 914 may include a mouse, a trackball, a stylus, a pen, a touch screen, cursor direction keys, or other mechanisms to cause movement of a cursor.

Communication device 916 links control unit 950 to a signal line 920 (e.g., which may connect to a network) that may include multiple processing systems and in one embodiment is a network controller. The network of processing systems may comprise a local area network (LAN), a wide area network (WAN) (e.g., the Internet), and/or any other interconnected data path across which multiple devices may communicate. The control unit 950 also has other conventional connections to other systems such as a network for distribution of files (media objects) using standard network protocols such as TCP/IP, http, https, and SMTP as will be understood to those skilled in the art.

One or more I/O devices 918 are coupled to the bus 908. These I/O devices may be part of the other systems (not shown).

It should be apparent to one skilled in the art that computer system 900 may include additional or fewer components than those shown in FIG. 9 without departing from the spirit and scope of the present invention. For example, additional input/output devices 918 may be coupled to control unit 950 including, for example, an RFID tag reader, digital still or video cameras, or other devices that may or may not be equipped to capture and/or download electronic data to control unit 950. One or more components could also be eliminated such as the input, e.g., keyboard 912 & cursor control 914.

As is known in the art, the computer system 900 is adapted to execute computer program modules for providing functionality described herein. In this description, the term “module” refers to computer program logic for providing the specified functionality. A module can be implemented in hardware, firmware, and/or software. Where any of the modules described here are implemented as software, the module can be implemented as a standalone program, but can also be implemented in other ways, for example as part of a larger program, as a plurality of separate programs, or as one or more statically or dynamically linked libraries. It will be understood that the modules described here represent one embodiment of the present invention. Certain embodiments may include other modules. In addition, the embodiments may lack modules described herein and/or distribute the described functionality among the modules in a different manner. Additionally, the functionalities attributed to more than one module can be incorporated into a single module. In one embodiment of the present invention, the modules are stored on the data storage 906, loaded into the memory 904, and executed by the processor 902. Alternatively, hardware or software modules may be stored elsewhere within the computer system 900.

Referring now to FIG. 10, it shows a block diagram of a memory unit 904 of the computer system 900 according to one embodiment of the present invention.

The memory unit 904 comprises an operating system 1002, applications 1004, a control module 1006, a volume and concentration module 1005, temporal evolution module 1007, a biological and chemical transformation module 1009, a depth-time threshold module 1008, a measurement module 1010, a grade module 1012, a storage module 1014, a location module 1016, a unit calculation module 1018, an identifier assignment module 1020, an indexing module 1022, a database maintenance module 1024, a registration module 1026, and a third party access module 1028. Those skilled in the art will recognize that the memory 904 also includes buffers for storing data and other information temporarily during the processes associated with the methods described herein. As noted above, the memory unit 904 stores instructions and/or data that may be executed by processor 902. The instructions and/or data comprise code for performing any and/or all of the techniques described herein. These modules 1002-1028 are coupled by bus 908 to the processor 902 for communication and cooperation with other aspects of the system 900.

The operating system 1002 may be one of a conventional type such as, WINDOWS®, Mac OS X®, SOLARIS® or LINUX®-based operating systems, or may be a custom operating system that is accessible to user via an application interface.

The memory unit 904 includes one or more application programs 1004 including, without limitation, drawing applications, word processing applications, electronic mail applications, search application, and financial applications. In one embodiment, the applications 1004 specifically utilize the unique capabilities of the other modules or units of memory 904.

The control module 1006 is adapted for control of and communication with the other modules of the memory 904. The operation of the control module 1006 will be apparent from the description of the figures below. While the control module 1006 is shown as a separate module of the memory 904, those skilled in the art will recognize that the control module 1006 in another embodiment may be distributed as routines in the other modules.

The volume and concentration module 1005 is software and routines for determining the volume and concentration of the chemical, physical, and biological components of the bloom and resulting from the bloom as described herein and is one means for doing so. The areal extent of the bloom and its associated chemical, physical, and biological components at a plurality of depths is determined by a number of techniques including calculations and models applied to satellite data, to seaglider and other autonomous vehicle data, to instrumental measurement data from ships, sediment traps, hydrocasts, moorings, or other sources. The locations of data from seagliders and autonomous vehicles as well as instrumental measurement data are determined by reference to GPS and other satellite systems. The areal extent of the bloom and concentrations of its components may be calculated and or modeled from different input data at different depths and at different times, e.g., from satellite data and instrumental measurements at near surface depths and from seaglider data and instrumental measurements at subsurface depths. The volume and concentration module includes calculations and models that interpolate and transform the discrete depth and concentration information to volume and concentration data that can be used to calculate the total carbon sequestration of the bloom, of depth intervals in the bloom, of discrete points in the bloom or of discrete volumes in the bloom. The volume and concentration module 1005 is coupled to the bus 908 for communication to other modules and or other aspects of computer system 900.

The temporal evolution module 1007 is software and routines for associating the areal extent data and volume calculations with the time of measurements from satellites, autonomous vehicles, and instrument measurements to determine the temporal evolution of the bloom and its chemical, physical, and biological components as described herein and is one means for doing so. All satellite, seaglider, and instrumental measurements used in calculating the concentration of the bloom and its chemical, physical, and biological components are associated with data for the time of their collection as well as the GPS or other satellite-generated location data. The temporal evolution module is software and routines for associating the data for the time of data collection to the concentration data from the volume and concentration module. These calculations for determining temporal evolution of the bloom and its components can be used to calculate fluxes of materials between depths and volumes of the bloom and rates of transformation of bloom components. The temporal evolution module 1007 is coupled to the bus 908 for communication to other modules and or other aspects of computer system 900.

The biological and chemical calculation module 1009 is software and routines for calculating the biogeochemical transformations of the bloom components as described herein and is one means for doing so. It includes, but is not limited to changes in the concentration of oxygen throughout the volume influenced by the bloom at a plurality of times during metabolism of the organic carbon produced in the bloom, or the generation of N2O at a plurality of times during the decomposition of nitrogen-containing organic material. It should be apparent to one skilled in the art that the module may contain software and routines for other chemical, physical, and biological transformations of blooms components. The biological and chemical calculation module may include software and routines that combine calculation of biogeochemical transformations with calculations and mathematical models of physical movement of ocean waters and their interaction with the atmosphere to calculate changes caused by the project that occur at some time after the implementation phase. The biological and chemical calculation module 1009 is coupled to the bus 908 for communication to other modules and to other aspects of computer system 900.

The depth-time threshold module 1008 is software and routines for determining a plurality of minimum depth thresholds associated with a location in the ocean as described herein. Each depth threshold corresponds to a predetermined minimum time period for the length of time until ocean water will be exposed to the atmosphere according to one embodiment of the present invention. The depth-time threshold module 1008 is coupled to the bus 908 for communication to other modules and or other aspects of computer system 900.

The sequestration module 1010 is software and routines for calculating carbon sequestered below each minimum depth threshold following an ocean fertilization project from the measurements, calculations and models as described herein according one embodiment of the present invention. The measurement module 1010 is coupled to the bus 908 for communication to other modules and or other aspects of computer system 900.

The grade module 1012 is software and routines for assigning quality grades to the measured tons of carbon such that carbon sequestered below a minimum depth is associated with the assigned grade as described herein according to one embodiment of the present invention. The grade module 1012 is coupled to the bus 908 for communication to other modules and or other aspects of computer system 900.

The storage module 1014 is software and routines for storing data associated with the ocean fertilization project in a quality grade database, the data including the assigned quality grades as described herein according to one embodiment of the present invention. The storage module 1014 is coupled to the bus 908 for communication to other modules and or other aspects of computer system 900. The storage module 1014 also includes software and routines for storing the new ocean fertilization project data in response to receiving at the project tracking database data corresponding to the execution of the new ocean fertilization project as described herein.

The location module 1016 is software and routines for identifying an ocean fertilization project location in which carbon has been sequestered as described herein according to one embodiment of the present invention. The location module 1016 is coupled to the bus 908 for communication to other modules and or other aspects of computer system 900.

The unit calculation module 1018 is software and routines for calculating a number of predetermined mass units (e.g., tons) of the sequestered carbon stored by the ocean fertilization project as described herein according to one embodiment of the present invention. The unit calculation module 1018 is coupled to the bus 908 for communication to other modules and or other aspects of computer system 900.

The identifier assignment module 1020 is software and routines for associating an identifier with each of the predetermined mass units of the sequestered carbon as described herein according to one embodiment of the present invention. The identifier assignment module 1020 is coupled to the bus 908 for communication to other modules and or other aspects of computer system 900.

The indexing module 1022 is software and routines for indexing the identifiers for the ocean fertilization project in a project tracking database as described herein according to one embodiment of the present invention. The indexing module 1022 is coupled to the bus 908 for communication to other modules and or other aspects of computer system 900.

The database maintenance module 1024 is software and routines for maintaining a project tracking database comprising stored data for prior ocean fertilization projects as described herein according to one embodiment of the present invention. The database maintenance module 1024 is coupled to the bus 908 for communication to other modules and or other aspects of computer system 900.

The registration module 1026 is software and routines for registering the new ocean fertilization project with the project tracking database in response to receiving at a project tracking database a registration request for a new ocean fertilization project prior to execution of the new ocean fertilization project as described herein according to one embodiment of the present invention. The registration module 1026 is coupled to the bus 908 for communication to other modules and or other aspects of computer system 900.

The third party access module 1028 is software and routines for allowing access to at least a portion of the stored data for prior ocean fertilization projects and stored new ocean fertilization project data in response to a request for access to the project tracking database as described herein according to one embodiment of the present invention. The third party access module 1028 is coupled to the bus 908 for communication to other modules and or other aspects of computer system 900.

The modules 1008-1028 may be stored on a computer on land, and might receive, e.g., via signal line 920, information from instruments on a ship, instruments at various locations in the ocean or at the ocean surface, instruments on land, historical data (e.g., regarding dissolved organic or inorganic carbon measurements, atmospheric CO2 measurements, measurements of inert tracers, such as chlorofluorocarbons, chemical or radioisotopes, carbon isotopes, etc., ocean water age maps, and so forth), satellite readings, sediment trap readings, deep water pump readings, thorium isotopic measurements, carbon system parameters, thermistor readings, particulate organic carbon flux measurements, and so forth (as described in more detail above), each of which can provide data regarding the fertilization area. This information can be received/transmitted wirelessly or by cable, via a satellite, by acoustic transmission, by optical transmission, by transmission on a physical medium (e.g., disk or memory card), via radiofrequency, via infrared, via a network connection, or by other means. Information can be received in real-time as new readings are taken or can be received in advance and stored for later usage. The modules 1008-1028 can further conduct various calculations based on the information received.

Those of skill in the art will recognize that other embodiments can have different and/or additional modules than those shown in FIG. 10. Likewise, the functionalities can be distributed among the modules in a manner different than described herein.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims. All scientific papers, patents, and other referenced documents are hereby incorporated by reference in their entirety for all purposes.

What is claimed is:

1. A computer-implemented method of inventorying carbon storage unit segments in an ocean fertilization project, comprising:
identifying an ocean fertilization project location in which carbon has been sequestered;
calculating a number of predetermined mass units of the sequestered carbon stored by the ocean fertilization project;
associating an identifier with each of the predetermined mass units of the sequestered carbon;
indexing the identifiers for the ocean fertilization project in a project tracking database.

2. The computer-implemented method of claim 1, wherein the number of predetermined mass units are tons.

3. The computer-implemented method of claim 1, wherein the number of predetermined mass units includes a fraction of a ton.

4. The computer-implemented method of claim 1, wherein the database provides user access to information about the fertilization project.

5. The computer-implemented method of claim 1, wherein identifying the ocean fertilization project location includes receiving GPS information.

6. A computer system for inventorying carbon storage unit segments in an ocean fertilization project, comprising:
a processor;
a location module for identifying an ocean fertilization project location in which carbon has been sequestered;
a unit calculation module for calculating a number of predetermined mass units of the sequestered carbon stored by the ocean fertilization project;
an identifier assignment module for associating an identifier with each of the predetermined mass units of the sequestered carbon;
an indexing module for indexing the identifiers for the ocean fertilization project in a project tracking database.

7. The system of claim 6, wherein the predetermined mass unit is a ton of CO2.

8. The system of claim 6, wherein additional information about the predetermined mass unit is stored with the identifier.

9. The system of claim 6, wherein identifying the ocean fertilization project location includes receiving GPS information.

10. A computer program product for inventorying carbon storage unit segments in an ocean fertilization project, comprising:
a computer readable storage medium;
computer program code, stored on the storage medium, for:
identifying an ocean fertilization project location in which carbon has been sequestered;
calculating a number of predetermined mass units of the sequestered carbon stored by the ocean fertilization project;
associating an identifier with each of the predetermined mass units of the sequestered carbon;
indexing the identifiers for the ocean fertilization project in a project tracking database.

11. The computer program product of claim 10, wherein additional information about the predetermined mass unit is stored with the identifier.

12. A method of registration and tracking of ocean fertilization project data, comprising:
maintaining a project tracking database comprising stored data for prior ocean fertilization projects comprising information about the project location, timing, and the areal extent or boundary of the project;
in response to receiving at a project tracking database a registration request for a new ocean fertilization project prior to execution of the new ocean fertilization project, registering the new ocean fertilization project with the project tracking database;
in response to receiving at the project tracking database data corresponding to the execution of the new ocean fertilization project, storing the new ocean fertilization project data; and
in response to a request for access to the project tracking database, allowing access to at least a portion of the stored data for prior ocean fertilization projects and stored new ocean fertilization project data.

13. The method of claim 12, wherein maintaining comprises updating the database with effects of the project discovered after project completion.

14. The method of claim 12, wherein the access to at least a portion of the stored data comprises third party verification.

15. A system for registration and tracking of ocean fertilization project data, comprising:
a database maintenance module for maintaining a project tracking database comprising stored data for prior ocean fertilization projects comprising information about the project location, timing, and the areal extent or boundary of the project;
a registration module for registering a new ocean fertilization project with the project tracking database in response to receiving at a project tracking database a registration request for the new ocean fertilization project prior to execution of the new ocean fertilization project;
a storage module for storing the new ocean fertilization project data in response to receiving at the project tracking database data corresponding to the execution of the new ocean fertilization project; and
a third party access module for allowing access to at least a portion of the stored data for prior ocean fertilization projects and stored new ocean fertilization project data in response to a request for access to the project tracking database.

16. The system of claim 15, wherein maintaining comprises adding later-discovered information about the prior projects to the database.

17. The system of claim 15, wherein the access to at least a portion of the stored data comprises third party verification.

18. A computer program product for registration and tracking of ocean fertilization project data, comprising:
a computer readable storage medium;
computer program code, stored on the storage medium, for:
maintaining a project tracking database comprising stored data for prior ocean fertilization projects comprising information about the project location, timing, and the areal extent or boundary of the project;
in response to receiving at a project tracking database a registration request for a new ocean fertilization project prior to execution of the new ocean fertilization project, registering the new ocean fertilization project with the project tracking database;
in response to receiving at the project tracking database data corresponding to the execution of the new ocean fertilization project, storing the new ocean fertilization project data; and
in response to a request for access to the project tracking database, allowing access to at least a portion of the stored data for prior ocean fertilization projects and stored new ocean fertilization project data.

19. The computer program product of claim 18, wherein maintaining comprises adding later-discovered information about the prior projects to the database.

20. The computer program product of claim 18, wherein the access to at least a portion of the stored data comprises third party verification.
